(19) United States
(12) Patent Application Publication
(10) Pub. No.: US 2016/0283482 A1
(43) Pub. Date: Sep. 29, 2016

(54) A METHOD OF PRESENTING INFORMATION ON A SEARCH RESULT PAGE

(71) Applicant: YANDEX EUROPE AG, Luzern (CH)

(72) Inventors: Sergei Sergeevich TOMILOV, Uralskiy village, Perm region (RU); Aleksandr Vladimirovich MOISEYEV, Moscow (RU)

(21) Appl. No.: 15/036,827

(22) PCT Filed: Nov. 11, 2013
(86) PCT No.: PCT/RU2013/001024

§ 371 Date: May 16, 2016

(51) Int. Cl. G06F 17/30; G06F 3/0484; G06Q 30/02

(52) U.S. Cl. CPC G06F 17/3053; G06F 17/30554; G06Q 30/0277; G06F 3/04842

(57) ABSTRACT

There is provided a method of presenting a search result to a user, the search result having been generated in response to a search query received from the user. The method is executable at a server. The method comprises: causing an electronic device associated with the user to execute displaying a search result page (SERP), the SERP including a search result line associated with a resource being deemed responsive to the search query; causing the electronic device to execute displaying within the search result line a first informational snippet associated with the search result: responsive to receipt of a user instruction, causing the electronic device to execute displaying a second informational snippet associated with the search result, the displaying being done in close proximity to the first informational snippet within the SERP; the second informational snippet providing additional information about the search result.

### CROSS-REFERENCE

None.

### FIELD

The present technology relates to search engines in general and specifically to a system and method for presenting information on a search result page.

### BACKGROUND

Various global or local communications networks (the Internet, the World Wide Web, local area networks and the like) offer a user a vast amount of information. The information includes a multitude of contextual topics, such as but not limited to, news and current affairs, maps, company information, financial information and resources, traffic information, games and entertainment related information. Users use a variety of client devices (desktop, laptop, notebook, smartphone, tablets and the like) to have access to rich content (like images, audio, video, animation, and other multimedia content from such networks).

Generally speaking, a given user can access a resource on the communications network by two principle means. The given user can access a particular resource directly. either by typing an address of the resource (typically an URL or Universal Resource Locator. such as www.webpage.com) or by clicking a link in an e-mail or in another web resource. Alternatively, the given user may conduct a search using a search engine to locate a resource of interest. The latter is particularly suitable in those circumstances, where the given user knows a topic of interest, but does not know the exact address of the resource she is interested in.

There are numerous search engines available to the user. Some of them are considered to be general purpose search engines (such as Yandex™, Google™, Yahoo™ and the like). Others are considered to be vertical search engines i.e. search engines dedicated to a particular topic of search—such as Momondo™ search engine dedicated to searching flights.

Irrespective of which search engine is used, the search engine is generally configured to receive a search query from a user, to perform a search and to return a ranked search results page (SERP) to the user. Several attempts have been made to improve the design of the SERP in the strive to enable the user to more easily and faster appreciate search results.

For example, where a user uses the Google™ search engine to search for exchange rates. For example, the user may have entered a search query “Exchange rate 1 Canadian Dollar to US Dollar”. The user is presented with a SERP a screenshot of which is depicted in FIG. 1 as a screenshot 100. Within the screen shot 100, the user is presented with several conventionally-known fields. Amongst these fields are: a query interface 102 and a search results interface 104. The general purpose of the query interface 102 is to enable the user (not depicted) to enter her query or a “search string” (which in this case is “Exchange rate 1 Canadian Dollar to US Dollar”). The general purpose of the search results interface 104 is to provide search results that are responsive to the user query entered into the query interface 102.

Within the search results interface 104 there is shown a SERP 106, the SERP 106 having several components. Within the SERP 106, there is provided an advertising portion 108 containing one or more sponsored or paid-for messages, a general search result portion 110 (containing general search results) and a widget portion 112. Within the widget portion 112, the user is able to undertake several interactive actions. For example, the user is able to change the amount and/or the currencies involved in the exchange rate calculations. Responsive to the user changes, the widget potion 112 provides the appropriate answer. Now, it should be noted that the widget portion 112 is associated with a vertical service of Google—in other words, it was specifically built for the Google currency exchange vertical service.

In another example, let it be assumed that the user has typed in a query (using the query interface 102), the query containing: “Cheap flights Toronto to Moscow”. The user is presented with a SERP a screenshot of which is represented in FIG. 2 as a screenshot 200. Within the screen shot 200, the user is presented with several conventionally-known fields. Amongst these fields are: a query interface 102 and a search results interface 104. Within the search results interface 104 there is shown a SERP 206, the SERP 206 having several components. Within the SERP 206, there is provided an advertising portion 208 containing one or more sponsored or paid-for messages, a general search result portion 210 (containing general search results) and a widget portion 212. Within the widget portion 212, the user is able to undertake several interactive actions. For example, the user is able to change the departure date and/or the return date for the flights sought.

Responsive to the user changes, the widget portion 212 will provide the appropriate output, including available airlines, flight duration and approximate price indication.

PCT patent application 2012/160567 discloses a system and method for dynamic and active search engine. A method includes displaying active resources and active search results based on monitoring, tracking, crawling, registering, subscribing, identifying active resources from one or more sources, receiving, updating, recording, logging, storing, indexing and processing said active resources and active searchable resources from one or more sources and generating, updating, sending, publishing, presenting & providing request and/or search query specific active resources or active search results to active searching user or requestor. A method enables dynamic, customize, unified active search engine, active search results, active ranking, and active advertisements based on identified, dynamic, contextual & accessible active link(s).

### SUMMARY

It is an object of the present technology to ameliorate at least some of the inconveniences present in the prior art.

According to a first broad aspect of the present technology, there is provided a method of presenting a search result to a user, the search result having been generated in response to a search query received from the user. The method can he executable at a server. The method comprises causing an electronic device associated with the user to execute displaying a search result page (SERP), the SERP including a search result line associated with a resource being deemed responsive to the search query; causing the electronic device to execute displaying within the search result line a first informational snippet associated with the search result; responsive to receipt of a user instruction, causing the electronic device to execute displaying a second informational snippet associated with the search result, the displaying being done in close proximity to the first informational snippet within the SERP; the second informational snippet providing additional information about the search result.

In some implementations, the method further includes receiving an indication of the user instruction. Receiving of the indication can be executed in response to the user actuating an actuation button on the SERP.

In some implementations, as part of executing the displaying within the search result line a first informational snippet associated with the search result, the method further comprises causing displaying of the actuation button in association with the first informational snippet.

In some implementations, the displaying a second informational snippet comprises displaying the second information snippet without leaving the SERP.

In some implementations, the displaying a second informational snippet comprises displaying the second information snippet without displaying a pop-up window.

In some implementations, wherein the displaying a second informational snippet comprises displaying the second information snippet below the first information snippet.

In some implementations, the displaying a second informational snippet comprises displaying the second information snippet to the right of the first information snippet.

In some implementations, the displaying a second informational snippet comprises displaying the second information snippet in place of the first information snippet.

In some implementations, the displaying a second informational snippet comprises displaying the second information snippet while at least partially overlaying the second information snippet over the first information snippet.

In some implementations, the second information snippet provides a subset of information from a resource associated with the search result line.

In some implementations, the subset of information allows interactive options to the user.

In some implementations, wherein the subset of information allows the user to obtain an answer to the search query without leaving the SERP.

In some implementations, the causing the electronic device to execute displaying within the search result line a first informational snippet comprises transmitting a first trigger to the electronic device, the first trigger being instrumental in causing the electronic device to display the first information snippet.

In some implementations, the causing the electronic device to execute displaying within the search result line a second informational snippet comprises transmitting a second trigger to the electronic device, the second trigger being instrumental in causing the electronic device to display the second information snippet.

In some implementations, the causing the electronic device to execute displaying within the search result line a first informational snippet comprises transmitting a first trigger to the electronic device, the first trigger being instrumental in causing the electronic device to display the first information snippet; and wherein the causing the electronic device to execute displaying within the search result line a second informational snippet comprises transmitting a second trigger to the electronic device, the second trigger being instrumental in causing the electronic device to display the second information snippet.

In some implementations, the transmitting a second trigger to the electronic device is executed upon receipt of a user instruction.

In some implementations, the transmitting a second trigger to the electronic device is executed concurrently with comprises transmitting a first trigger to the electronic device, and wherein the method further comprises transmitting a third trigger, the third trigger being instrumental in causing the electronic device to only display the first interactive snippet until receipt of the user instruction.

According to another broad aspect of the present technology, there is provided a server for presenting a search result to a user, the search result having been generated in response to a search query received from the user; the server having a non-transient computer usable information storage medium that stores computer executable instructions, which instructions when executed are configured to render the server operable to execute: causing an electronic device associated with the user to execute displaying a search result page (SERP), the SERP including a search result line associated with a resource being deemed responsive to the search query; causing the electronic device to execute displaying within the search result line a first informational snippet associated with the search result; responsive to receipt of a user instruction, causing the electronic device to execute displaying a second informational snippet associated with the search result, the displaying being done in close proximity to the first informational snippet within the SERP; the second informational snippet providing additional information about the search result.

According to another broad aspect of the present technology, there is provided a method of presenting a search result to a user, the search result having been generated in response to a search query received from the user. The method can be executable at the electronic device associated with the user. The method comprises: displaying a search result page (SERP), the SERP including a search result line associated with a resource being deemed responsive to the search query; displaying within the search result line a first informational snippet associated with the search result; responsive to receipt of a user instruction, displaying a second informational snippet associated with the search result, the displaying being done in close proximity to the first informational snippet within the SERP; the second informational snippet providing additional information about the search result.

In the context of the present specification, a “server” is a computer program that is running on appropriate hardware and is capable of receiving requests (e.g. from client devices) over a network, and carrying out those requests, or causing those requests to he carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a screenshot 100, the screenshot 100 depicting a SERP implemented in accordance with the known techniques.

FIG. 2 depicts a screenshot 200, the screenshot 200 depicting a SERP implemented in accordance with other known techniques.

FIG. 3 is a schematic diagram depicting a system 300, the system 300 being implemented in accordance with non-limiting embodiments of the present technology.

FIG. 4 is a screen shot of a SERP implemented in accordance with non-limiting embodiments of the present technology, the SERP displaying a first information snippet in association with a search result line.

FIG. 5 is a screen shot of the SERP of FIG. 4, wherein the SERP is displaying a second information snippet in association with the search result line.

FIG. 6 is a screen shot of a portion of a SERP implemented in accordance with yet another non-limiting embodiment of the present technology, the portion of the SERP displaying a first information snippet in association with a search result line.

FIG. 7 is a screen shot of the portion of the SERP of FIG. 6, wherein the portion of the SERP is displaying a second information snippet in association with the search result line.

FIG. 8 is a block diagram of a method 800, the method being implementable in accordance with a non-limiting embodiment of the present technology, the method 800 being executable within the system 300 of FIG. 3.

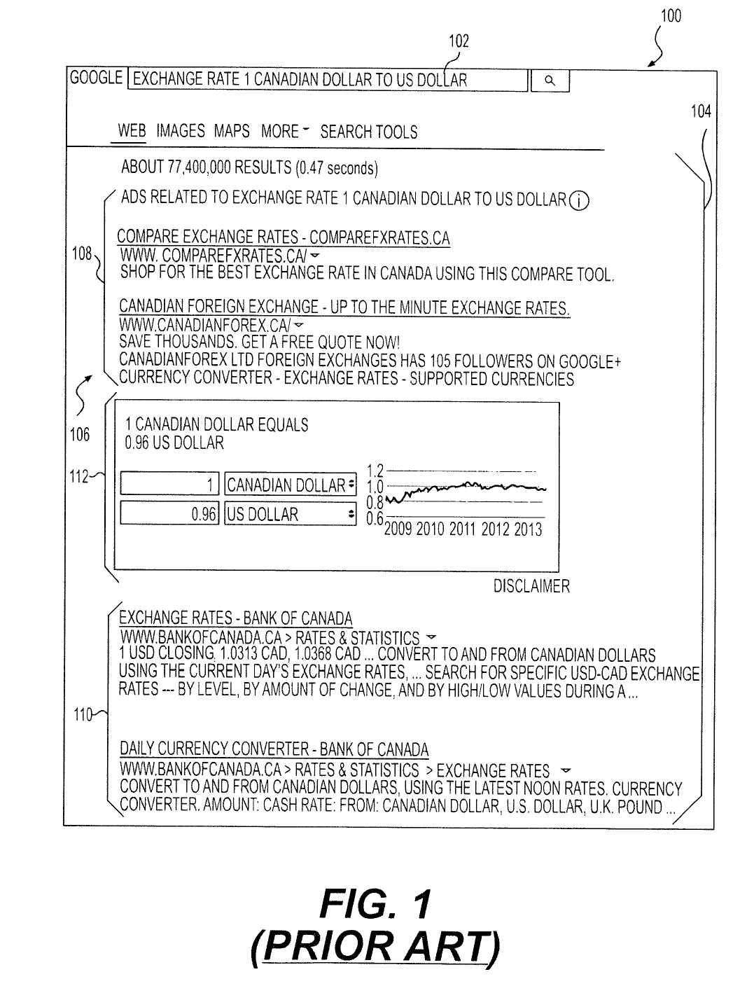

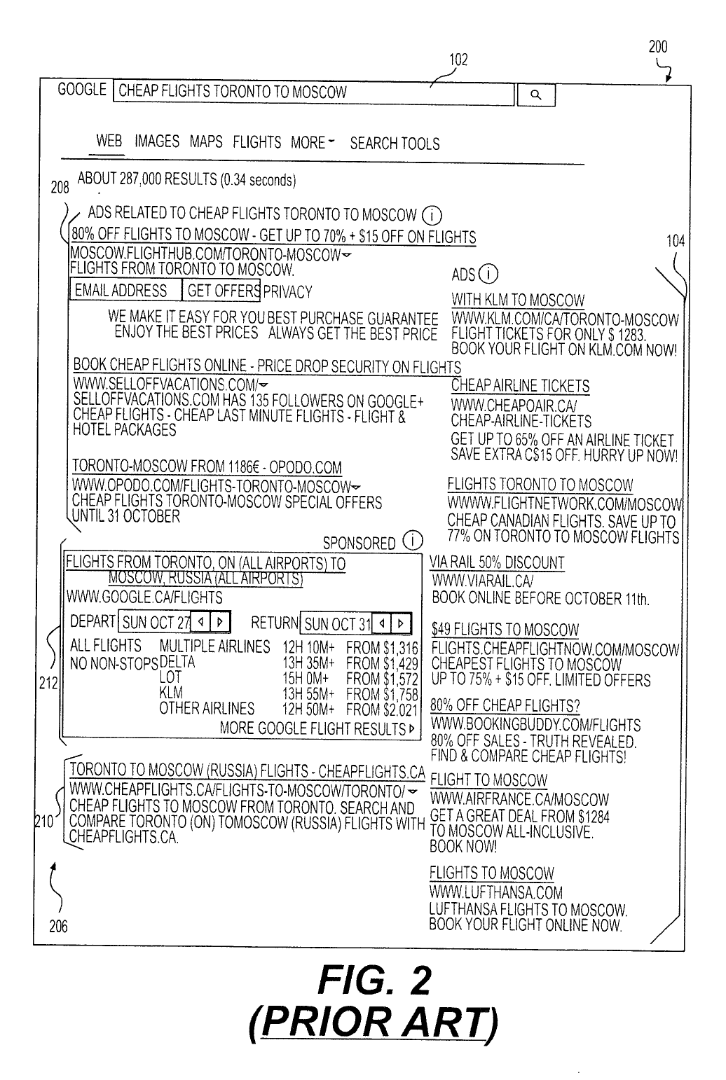

### DETAILED DESCRIPTION

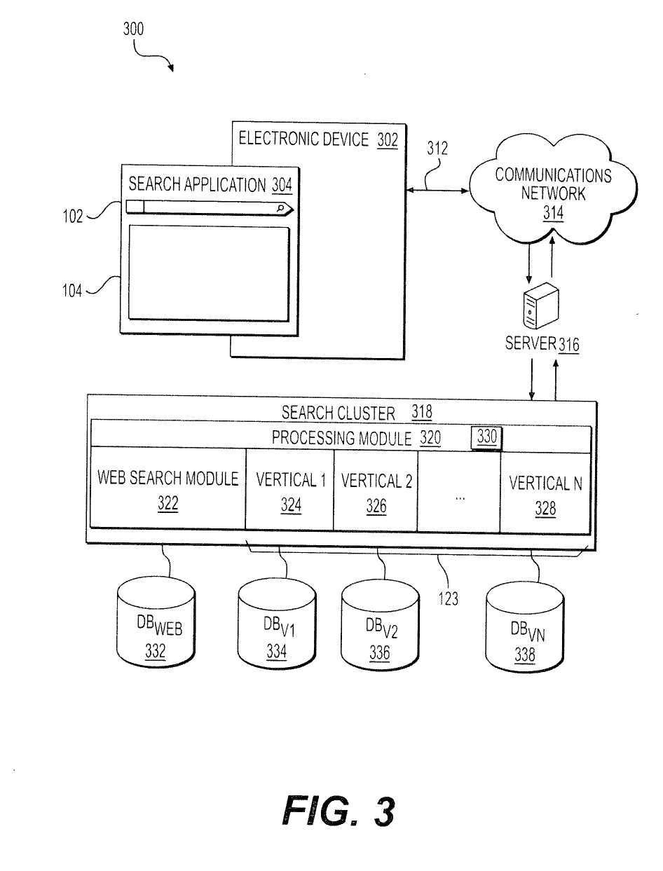

Referring to FIG. 3, there is shown a schematic diagram of a system 300, the system 300 being suitable for implementing non-limiting embodiments of the present technology. It is to be expressly understood that the system 300 is depicted as merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 300 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the system 300 may provide in certain instances simple implementations of the present technology, and that where such is the case they have been presented in this manner as an aid to understanding. As persons skilled in the art would understand, various implementations of the present technology may be of a greater complexity.

The system 300 comprises an electronic device 302. The electronic device 302 is typically associated with a user (not depicted) and, as such, can sometimes be referred to as a “client device”. It should be noted that the fact that the electronic device 302 is associated with the user does not need to suggest or imply any mode of operation—such as a need to log in, a need to he registered or the like.

The implementation of the electronic device 302 is not particularly limited, but as an example, the electronic device 302 may be implemented as a personal computer (desktops, laptops, netbooks, etc.), a wireless communication device (a cell phone, a smartphone, a tablet and the like), as well as network equipment (a router, a switch, or a gateway). The electronic device 302 comprises hardware and/or software and/or firmware (or a combination thereof), as is known in the art, to execute a search application 304. Generally speaking, the purpose of the search application 304 is to enable the user (not depicted) to execute a search, such as the above mentioned web search using the above-mentioned search engine. To that end, the search application comprises the aforementioned query interface 102 and search results interface 104.

How the search application 304 is implemented is not particularly limited. One example of the search application 304 may be embodied in a user accessing a web site associated with a search engine to access the search application 304. For example, the search application can be accessed by typing in an URL associated with Yandex search engine at www.vandex.ru. It should be expressly understood that the search application 304 can be accessed using any other commercially available or proprietary search engine.

In alternative non-limiting embodiments of the present technology, the search application 304 may be implemented as a browser application on a portable device (such as a wireless communication device). For example (but not limited) to those implementations, where the electronic device 302 is implemented as a portable device, such as for example, Samsung™ Galaxy™ SIII, the electronic device may be executing a Yandex browser application. It should be expressly understood that any other commercially available or proprietary browser application can be used for implementing non-limiting embodiments of the present technology.

The electronic device 302 is coupled to a communications network 314 via a communication link 312. In sonic non-limiting embodiments of the present technology, the communications network 314 can be implemented as the Internet. In other embodiments of the present technology, the communications network 314 can be implemented differently, such as any wide-area communications network, local-area communications network, a private communications network and the like.

How the communication link 312 is implemented is not particularly limited and will depend on how the electronic device 302 is implemented. Merely as an example and not as a limitation, in those embodiments of the present technology where the electronic device 302 is implemented as a wireless communication device (such as a smart-phone), the communicated link 102 can be implemented as a wireless communication link (such as but not limited to, a 3G communications network link, a 4G communications network link, a Wireless Fidelity, or WiFi® for short, Bluetooth® and the like). In those examples, where the electronic device 302 is implemented as a notebook computer, the communication link can be either wireless (such as the Wireless Fidelity, or WiFi® for short, Bluetooth® or the like) or wired (such as an Ethernet based connection).

It should be expressly understood that implementations for the electronic device 302, the communication link 312 and the communications network 314 are provided for illustration purposes only. As such, those skilled in the art will easily appreciate other specific implementational details for the electronic device 302, the communication link 312 and the communications network 314. As such, by no means, examples provided herein above are meant to limit the scope of the present technology.

Also coupled to the communications network is a server 316. The server 316 can be implemented as a conventional computer server. In an example of an embodiment of the present technology, the server 316 can be implemented as a Dell™ PowerEdge™ Server running the Microsoft™ Windows Server™ operating system. Needless to say, the server 316 can be implemented in any other suitable hardware and/or software and/or firmware or a combination thereof. In the depicted non-limiting embodiment of present technology, the server 316 is a single server. In alternative non-limiting embodiments of the present technology, the functionality of the server 316 may be distributed and may be implemented via multiple servers.

The server 316 is communicatively coupled (or otherwise has access) to a search cluster 318. The general purpose of the search cluster 318 is to perform searches in response to the user queries inputted via the query interface 102 and to output search results to be presented to the user using the search results interface 104. What follows is a description of one non-limiting embodiment of the implementation for the search cluster 318. However, it should be understood that there is a number of alternative non-limiting implementations of the search cluster 318 possible. It should be also expressly understood that in order to simplify the description presented herein below, the configuration of the search cluster 318 has been greatly simplified. It is believed that those skilled in the art will be able to appreciate implementational details for the search cluster 318 and for components thereof that may have been omitted for the purposes of simplification of the description.

Generally speaking the purpose of the search cluster 318 is to (i) conduct searches (details will be explained herein below); (ii) execute analysis of search results and perform ranking of search results; (iii) group results and compile the search result page (SERP) to be outputted to the electronic device 302. How the search cluster 318 is configured to execute searches is not particularly limited. Those skilled in the art will appreciate several ways and means to execute the search using the search cluster 318 and as such, several structural components of the search cluster 318 will only be described at a high level.

In some non-limiting embodiments of the present technology, the search cluster 318 comprises a processing module 320. The processing module 320 can execute several searches. including but not limited to, a general search and a vertical search. To that end, the processing module 320 comprises (or has access to) a web search module 322. The web search module 322 is configured to perform general web searches, as is known to those of skill in the art.

In some non-limiting embodiments of the present technology, processing module 320 can execute what is known as a multi-level search. These non-limiting embodiments can be implemented, for example, to increase the speed of the search and to obtain more relevant search results. In some non-limiting embodiments of the present technology, the web search module 322 can be responsible for executing the multi-level search.

To that end, the web search module 322 can execute the top level meta search, as will be discussed in greater detail herein below. The web search module 322 may also have access to a database DB_{WEB} 332, which database DB_{WEB} 332 may he accessed by the web search module 322 to conduct a middle level meta search and a bottom level search. Even though the database DB_{WEB} 332 is depicted as a single entity, in some non-limiting embodiments of the present technology, the database DB_{WEB} 332 can be implemented in a distributed manner, for example as a dedicated database for each of the middle level meta search and the bottom level search.

Also, even though the web search module 322 is depicted as a single entity, in alternative non-limiting embodiments of the present technology the web search module 322 may also be implemented in a distributed manner. For example, each of the distributed implementations of the web search modules 322 may be dedicated to search queries originating from a particular geographical region. In those non-limiting embodiments of the present technology, the processing module 320 may determine a location and/or an IP address associated with the electronic device 302 associated with the user who is submitting the search query. Based on the so-determined location and/or the IP address of the electronic device 302, the processing module 320 may forward the search query to one of the distributed web search modules 322 to perform the top level meta search.

The web search module 322 may also forward a request to the database DB_{WEB} 332 to perform the middle level meta search and the bottom level search. In some non-limiting embodiments of the present technology, the database DB_{WEB} 332 may have a portion (or a separate database) dedicated to the middle level meta search (for example, having a repository of frequently asked questions). The identification of the portion (or a separate database) of the database DB_{WEB} 332 responsible for the middle level meta search may be executed by the database DB_{WEB} 332 based on a so-called “CRC-code”. The portion (or a separate database) of the database DB_{WEB} 332 responsible for the middle level meta search may send a given generated query to a portion (or a separate database) of the database DB_{WEB} 332 responsible for the bottom level search.

However, in some non-limiting embodiments of the present technology, where the search query is already saved in cache of the portion (or the separate server) of the database DB_{WEB} 332 as part of the middle level meta search, the step of transmitting the query to the portion (or the separate database) of the database DB_{WEB} 332 responsible for the bottom level search may be omitted altogether. Naturally, in alternative embodiments of the present technology, even if the search query is already saved in cache of the portion (or the separate server) of the database DB_{WEB} 332 as part of the middle level meta search, the step of transmitting the query to the portion (or the separate database) of the database DB_{WEB} 332 responsible for the bottom level search may still be performed.

The processing module 320 further comprises (or has access to) a plurality of vertical search modules 323. In the depicted non-limiting embodiment, the plurality of vertical search modules includes a vertical 1 module 324, a vertical 2 module 326 and a vertical N module 328. It should be expressly understood that the number of modules within the plurality of vertical search modules 323 is not meant to be a limitation of embodiments of the present technology.

Merely for the purposes of ease of illustration, it shall be assumed that the vertical 1 module 324 is implemented as a vertical search domain for searching maps and other geographical information. As such, it can be said that the vertical 1 module 324 implements a map vertical search engine or, simply, a map service.

Furthermore, it shall be assumed that the vertical 2 module 326 is implemented as a vertical search module for searching images. As such, it can be said that the vertical 2 module 326 implements an images vertical search domain or, simply, an image service. For the various examples to be provided herein below, it shall he assumed, selectively, that the vertical N search module 328 can implement one of sports news, movies, weather, translation, wiki or movie theater services. It should be expressly understood that a number of additional or different services can be implemented as part of the plurality of vertical search modules 323.

In some non-limiting embodiments of the present technology, any given one of the plurality of vertical search modules 323 comprises or has access to one or more databases. These one or more databases host data associated with the particular service implemented by the given one of the plurality of vertical search modules 323.

To that extent, the vertical 1 module 324 has access to a database DB_{V1} 334. Recalling that the vertical 1 module 324 implements a map service, the database DB_{V1} 334 contains information related to geographical location of various objects and the associated maps. The vertical 2 module 326 has access to a database DB_{V2} 336 . Recalling that the vertical 2 module 326 implements an image service, the database DB_{V2} 336 can host a repository of various images. By the same token, the vertical N module 328 has access to a database DB_{VN} 338. Recalling that the vertical N module 328 implements selectively one of sports news, movies, weather, translation or movie theater services, the database DB_{VN} 338 can host a repository of data associated with the respective selective service.

Additionally or optionally and, as known to those skilled in the art, the one or more databases (such as the database DB_{V1} 334, DB_{V2} 336 and DB_{VN} 338) may be segregated into one or more separate databases. These segregated databases may be portions of the same physical database (such as the database DB_{V1} 334, database DB_{V2} 336 and database DB_{VN} 338) or may be implemented as separate physical entities. For example, one database within, let's say, the database DB_{V2} 336 could host the most popular/most frequently requested images in a given category, while another database within the database DB_{V2} 336 could host all the images available within the image service. Needless to say. the above has been provided as an illustration only and several additional possibilities exist for implementing embodiments of the present technology. Also, as is known to those of skill in the art, the search cluster 118 or the server 116 may execute a crawler algorithm—which algorithm causes the search cluster 118 or the server to “crawl” the Internet and index visited web sites into one or more of the databases (such as the database DB_{V1} 334, DB_{V2} 336 and DB_{VN} 338).

Furthermore, it is possible that some of the plurality of vertical search modules 323 may not implement a separate database. This is particularly true, but is not limited to, for example, the vertical N module 328 implementing a weather service. In this example, the vertical N module 328 implementing the weather service may not have a dedicated database. but may rather have access to a service widget repository 330. The service widget repository 330 may be implemented as data repository for one or more widget applications, as will be described in greater detail here below.

Each of the plurality of vertical search modules 323 is configured to perform vertical searches within the respective databases (i.e. database DB_{V1} 334, database DB_{V2} 336 and database DB_{VN} 338). However, it should be noted that the search capabilities of the plurality of vertical search modules 323 are not limited to searching the respective databases (i.e. database DB_{V1} 334, database DB_{V2} 336 and database DB_{VN} 338). As such, the plurality of vertical search modules 323 may perform other searches, as the need may be.

Also, for the purposes of the description presented herein, the term “vertical” (as in vertical search or in vertical search domain) is meant to connote a search performed on a subset of a larger set of data, the subset having been grouped pursuant to an attribute of data. For example, to the extent that the vertical 2 module 326 implements an image service, the vertical 2 module 326 searches a subset (i.e. images) of the set of data (i.e. all the data potentially available for searching), the subset of data being stored in the database DB_{V2} 336.

Merely for the purposes of simplifying the description to be presented herein, only a high level description of one approach to executing a search by the search cluster 318 will be presented herein below. It is expected that those skilled in the art will be able to configure the search cluster 318 in any number of known ways without undue experimentation or burden.

As has been mentioned above, in some non-limiting embodiments of the present technology, the processing module 320 can be configured to execute a search in a multi-level meta fashion. In some non-limiting embodiments of the present technology, the processing module 320 includes an http-interface (not depicted) for receiving the search request from the server 316.

When the processing module 320 receives the search query from the server 316, it sends the search query to the web search module 322. As has been alluded to above, in some non-limiting embodiments of the present technology, the sending of the search request to the web search module 322 may be based on the location and/or IP address associated with the electronic device 302, as may be determined by the processing module 320. The web search module 322 performs a search, which in some non-limiting embodiments of the present technology may include a multi-level search. To that extent, the web search module 322 executes some or all of the top level meta search, middle level middle search and the bottom level search.

In parallel or in sequence, the processing module 320 also transmits the search query to the plurality of vertical search modules 323 for performing the respective vertical searches. The responses from all the search sources (the plurality of vertical search modules 323 and the web search module 322, which may include the bottom level search, the middle level meta search and the top level meta search) are received and amalgamated by the processing module 320.

The processing module 320 then executes a ranking function to generate a ranked search results set. In other words, the processing module 320 ranks the search results by their relevancy to the search query submitted by the user. As those skilled in the art will appreciate, relevancy within this description shall mean how responsive a given search result is to the user query.

Those skilled in the art will appreciate various techniques available tor ranking search results. Just as an example and not as a limitation, some of the known techniques for ranking search results by relevancy are based on some or all of: (i) how popular a given search query or a response thereto is in either the plurality of vertical search modules 323 or in the bottom level search (or any other level of the multi level meta search); (ii) how many results have been returned by either the plurality of vertical search modules 323 or in the bottom level search (or any other level of the multi level meta search); (iii) whether the search query contains any determinative terms (such as “images”, “movies”, “weather” or the like), (iv) how often a particular search query is typically used with determinative terms by other users; and (v) how often other uses performing a similar search have selected a particular resource or a particular vertical search results when results were presented using the standard SERP.

Within this description, the term “determinative term” shall mean a word or a string of words indicative of the fact that a given search result is more likely to have the most relevant response to the user search query. For example. if the search query contains the term “images” it can be determined, by the processing module 320, that the vertical 2 module 326, being implemented as an image service, is likely to be the service that contains the most relevant results to the user query. Needless to say, only a sub set of these, or these combined to others or any combination of other factors my be taken into account when raking the search results for relevancy.

The search cluster 318 is then configured to transmit ranked search results to the server 316.

It should be noted that the above described architecture of system 300 of FIG. 3 has been depicted as an example only. Other non-limiting embodiments for the architecture of FIG. 3 are possible and will become apparent to those of skill in the art having benefit of the present disclosure. For example, the plurality of vertical search modules 323 may be accessed by the server 316 independently from the search cluster 318 and, therefore, may be located on a server other than the search cluster 318.

In some embodiments. the server 316 determines that at least one result within the received ranked search results has a hierarchical structure. Put another way, the “hierarchical structure” of a given search result means to denote a situation where a given search result is (or can be) associated with an information snippet, which information snippet can be broken down into a first information snippet portion and a second information snippet portion. Information snippets associated with search results are generally known. These are write-ups generated in association with search results with a goal to summarize the resource associated with the search result to enable the user to appreciate whether she is interested in the search result or not (or, put another way, if the search result is truly responsive to the user's search query).

The write-ups can be generated automatically by the server 316. For example, it is known to generate write ups based on key words resent in the search query by pulling sentences or portions thereof from the main page of the web site associated with the resource, the sentences or portions thereof containing the key words. Alternatively, the write-up can be based at least in part on information provided by the resource. An example of such a technology is disclosed in the co-owned patent application, having the title A METHOD OF PRESENTING INFORMATION ON A SEARCH RESULT PAGE and bearing attorney Docket Number 34055-220, content of which is hereby incorporated by reference in its entirety in all those jurisdictions where incorporation by reference is permissible.

Within embodiments of the present technology, the first information snippet can provide a first level of detail about the resource to the user. The second information snippet can provide a second level of detail about the resource to the user. In some implementations, the switch between the first information snippet and the second information snippet is executed upon appreciation of the user's desire to do so. For example, an actuation button can be provided in association with the first information snippet. Upon user actuation of the actuation button, the second information snippet can be presented to the user. In some embodiments the second information snippet is presented in close proximity to the first information snippet. As an example, the second information snippet can be presented immediately below the first information snippet. Alternatively, the second information snippet can be presented side by side relative to the first information snippet. In yet alternative embodiments, the second information snippet can overlay the first information snippet, at least partially.

It should be noted that the second information snippet is displayed without user leaving the SERP. In some embodiments, the second information snippet is displayed without generating a pop-up window.

Hence, responsive to receipt of a user instruction, a second informational snippet associated with the search result is displayed in close proximity to the first informational snippet within the SERP; the second informational snippet providing additional information about the search result.

The type of additional information that the second information snippet provides is not particularly limited and will depend, naturally, on the resource in question. What follows are some non-limiting examples of the implementation for the first information snippet and the second information snippet, examples being provided for the purposes of illustration of the various non-limiting embodiments disclosed herein.

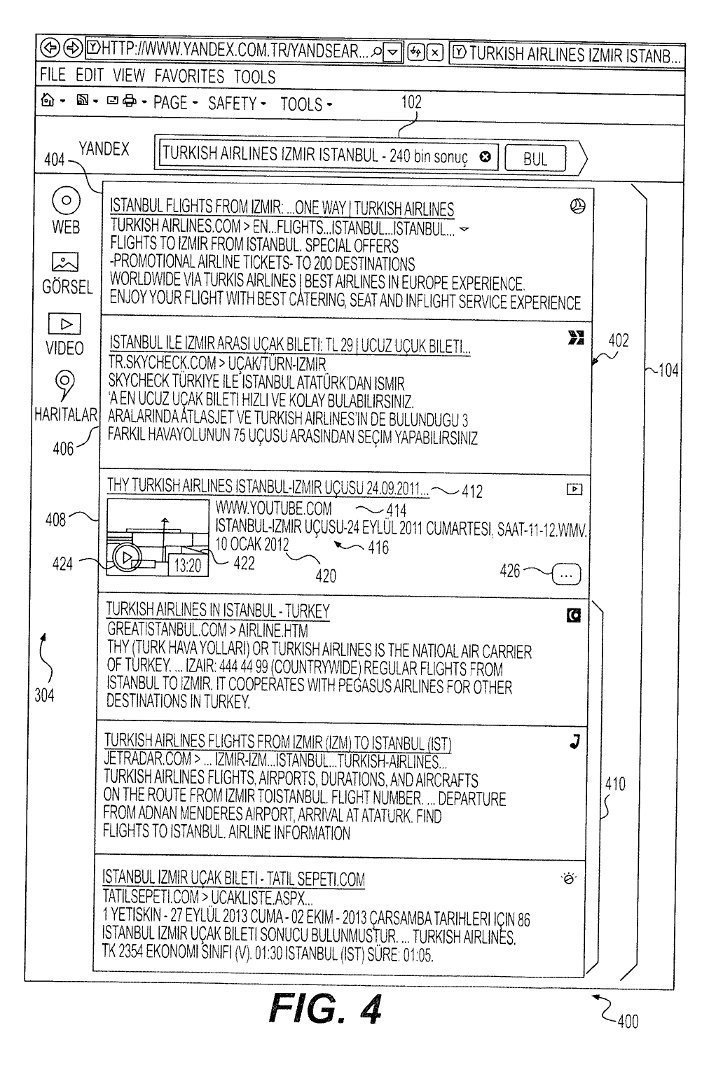

With reference to FIG. 4, there is depicted a screen shot 400. The screen shot 400 depicts a web browser with a search application 304 running therein. Within the illustrated embodiment, the web browser is Explorer™ accessing the Yandex™ search engine. However, in alternative embodiments, any commercially available or proprietary browser executing any commercially available or proprietary browser can be used.

To that extent the search application 304 implements the above-mentioned query interface 102 and search results interface 104. Within the query interface 102, a search string has been entered (namely “turkish airlines izmir istanbul”). Within the search results interface 104, a SERP 402 is presented, the SERP 402 containing search results responsive to the search query and ranked in accordance to their relevancy. The SERP 402 contains a first search line 404, a second search line 406 and a third search line 408. The SERP 402 further contains a plurality of additional search lines 410. Each of the search lines (i.e. the first search line 404, the second search line 406, the third search line 408 and the plurality of additional search lines 410) is associated with a search results.

As is known in the art, each one of the of the search lines (i.e. the first search line 404, the second search line 406, the third search line 408 and the plurality of additional search lines 410) provides information to the user. Generally, the information so provided is meant to enable the user to determine if the particular resource associated with the particular search line of the search lines (i.e. the first search line 404, the second search line 406, the third search line 408 and the plurality of additional search lines 410) is responsive to the user's search query.

Within the illustration of FIG. 4, some of the search lines (i.e. some of the first search line 404, the second search line 406, the third search line 408 and the plurality of additional search lines 410) are executed in accordance with known techniques. For example, the first search line 404, the second search line 406 and each of the plurality of additional search lines 410) are implemented in accordance general known techniques known in the art.

In accordance with embodiments of the present technology, it has been determined by the server 316 that the third search 408 is associated with a resource, which information can be split into a hierarchical structure. In other words, information associated with the search result associated with the third search line 408 can be associated with an information snippet, which information snippet can be broken down into a first information snippet portion and a second information snippet portion. The screenshot 400 of FIG. 4 shows a first information snippet 410, the first information snippet 410 providing a first information to the user about the resource. Within the illustrated embodiment, the first information snippet 410 includes a title field 412, a resource address field 414, a summary field 416, a last update date field 420 and a preview field 422.

Generally speaking, the title field 412, the resource address field 414, the summary field 416, the last update date field 420 are implemented as known in the art and provide, respectively, information on the title of the resource, the brief summary of the resource content and the date of the last update of the resource or the last date of indexing of the resource by the server 316. It should be noted that the above fields within the first information snippet 410 (namely, the title field 412, the resource address field 414, the summary field 416, the last update date field 420) are provided as examples only. As such, in alternative embodiments, the first information snippet 410 can be implemented with fewer or more fields, with a combination of these fields and different fields, as well as different fields all together.

According to embodiments of the present technology, the preview field 422 provides a visual snapshot of the resource associated with the third search line 408. Within this example, the resource associated with the third search line 408 comprises a video. As such, within this example, the preview field 422 contains a static snapshot of the video stored within the resource associated with the third search line 408. There is also provided a play button 424 in association with the preview field 422. The implementations of the play button 424, in general, are known. Within the illustrated embodiment, the play button 424 is implemented as a conventional circle with a triangle pointed to the right inside. Other configurations for the play button 424 are, of course, possible. Some special configurations for the play button 424 will be explained in detail herein below.

Hence, it can be the that the first information snippet 410 provides information to the user (in the form of the above-described various fields) that is meant to enable the user to determine if the resource associated with the third search line 408 is of interest to the user (i.e. if it is responsive to the user query that the user entered within the query interface 102).

Provided in accordance with embodiments of the present technology is an actuation button 426. The actuation button 426 allows the user to provide a user instruction indicative of the user desiring to see additional information associated with the resource associated with the third search line 408. Within the illustrated embodiment, the actuation button 426 is implemented as a square with three dots in it. This should not be the case in each implementation of the instant technology. As such, in alternative embodiments, the actuation button 426 can be implemented in a different form factor. As a non-exhaustive list of examples, the actuation button 426 can be implemented as an arrow pointing down, as an arrow pointing to the right, as a button with a word “More” or any other graphical or word-based form factor, which is generally indicative to the user submitting the search query and reviewing the SERP 402 that additional information is available.

For example, upon appreciating the information provided within the first information snippet 410, the user may determine that she is interested in the resource and may be desirable of obtaining additional information about the resource. Hence, the user may choose to actuate the actuation button 426. Upon the user actuation of the actuation button 426, the browser sends the request to the server 316 and, in response thereto, the server 316 furnishes to the electronic device 302 an indication of a second information snippet. In alternative embodiments, the indication of the second information snippet may have been received by the electronic device 302 together with the information for generating SERP 402. Within the latter implementations, the electronic device 302 also received a trigger to only display the first information snippet 410 and to store the second information snippet.

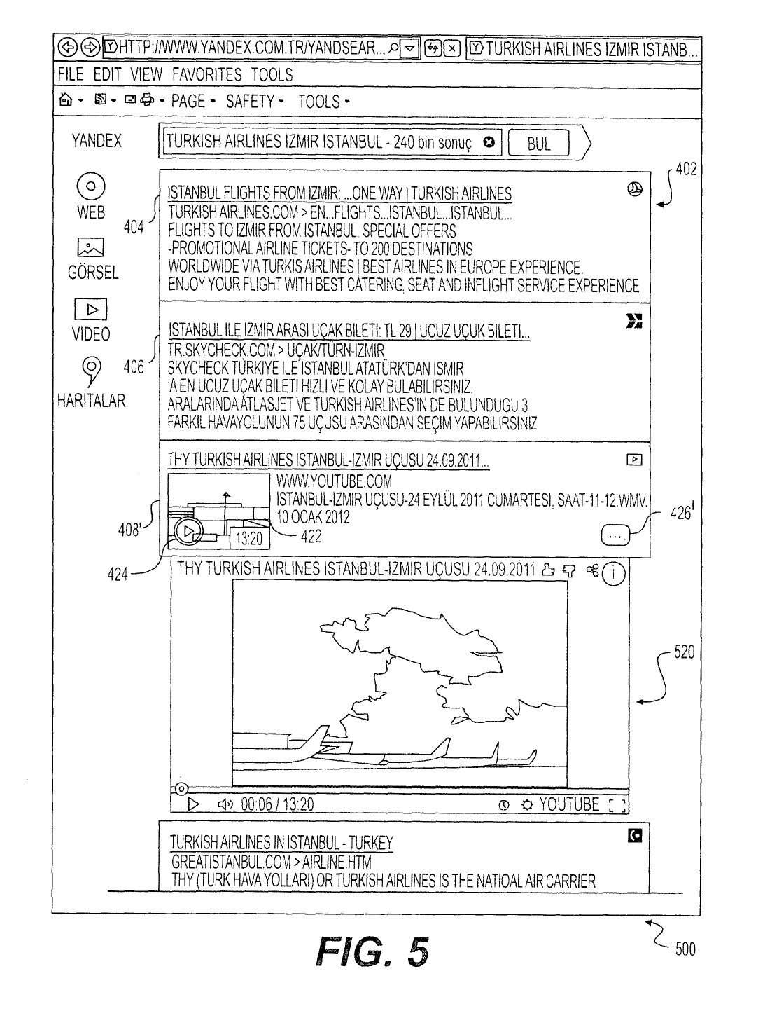

With reference to FIG. 5, there is depicted a screen shot 500. The screen shot 500 depicts the search results interface 104 of FIG. 4 upon activation of the actuation button 426. To that extent, the screen shot 500 shares a lot of components with the screen shot 400, which shared components will not be described here at any length.

The screen shot 500 depicts the SERP 402 that has been amended pursuant to receipt of the user instruction as a result of the user actuating the actuation button 426. To that end, an actuation button 426′ of FIG. 5 is “greyed out” to indicate to the user that it has been selected.

Each of the first search line 404, the second search line 406 and the plurality of the additional search lines 410 have not been changes (other than only a portion of the additional search lines 410 are visible within the screen shot 500 due to the changes that have occurred within the appearance and content of a third search line 408′. The third search line 408′ contains the first information snippet 410, much akin to the third search line 408. The third search line 408′ further comprises a second information snippet 520.

Generally speaking, the second information snippet 520 provides additional information about the resource associated with the third search line 408 (and the third search line 408, for that matter). Within specific illustration provided, the second information snippet 520 comprises the actual video stored within the resource associated with the third search line 408′. It is noted that within this illustration, the second information snippet 520 is fully functional in the sense that the user can interact with the second information snippet 520 to play the video, to pause playing of the video, to last forward the video, to rewind the video, to make the video full screen, to “like” using FaceBook™ and the like.

It is noted that the second information snippet 520 is displayed right within the SERP 402. Put another way, the second information snippet 520 is displayed without leaving the SERP 402. It can also be said that the second information snippet 520 is displayed without generating a pop up window, a separate web browser screen or a separate web browser tab.

Specifically, the second information snippet 520 is displayed in close proximity to the first information snippet 410. Within the illustrated embodiment, the second information snippet 520 is displayed immediately below the first information snippet 410. In alternative embodiments, the spatial relationship between the second information snippet 520 and the first information snippet 410 can be different. For example, the second information snippet 520 can be displayed to the right of the first information snippet 410. Alternatively, the second information snippet 520 can be displayed to the left of the first information snippet 410. It is also possible that the second information snippet 520 can be displayed on top of the first information snippet 410. Finally, it is contemplated that the second information snippet 520 can partially overlay first information snippet 410. Within some embodiments, it is contemplated that the second information snippet 520 can at last partially replace the first information snippet 410.

It is noted that in the illustrated embodiment, the second information snippet 520 enables the user to appreciate the nature of the resource associated with the third search line 408 in addition to the information provided by the first information snippet 410. In the specific illustration the second information snippet 520 allows the user to potentially get the answer to her query without leaving SERP 402. Additionally or alternatively, in the specific illustration the second information snippet 520 allows the user to potentially get the answer to her query without accessing the resource associated with the third search line 408. In alternative embodiments, however, rather than providing, the video itself within the second information snippet 520, the server 520 may have provided alternative types of additional information. Continuing with the example of the resource being a video, the second information snippet 420 may contain additional information describing the video, provide information regarding where and when the video was made, provide other users' comments about the video and the like.

It is recalled that there is also provided the play button 424 in association with the preview field 422. In some embodiments user's actuation of the play button 424 may have the same effect as the user's actuation of the actuation button 426. In alternative embodiments, user's actuation of the play button 424 may cause an appearance of a pop up window, a new tab or a new browser window displaying the video. Alternatively, actuation of the play button 424 may case the browser to be redirected to a website associated with the resource (which in this case would he a YouTube™ page hosting the video).

As has been alluded to earlier, the type of information provided within the first information snippet and the second information snippet is not particularly limited. However, it is fair to say that the information provided in the second information snippet is somewhat dependent from the information presented in the first information snippet. This is in a sense that the second information snippet can provide information that is more elaborate than the information provided in the first information snippet.

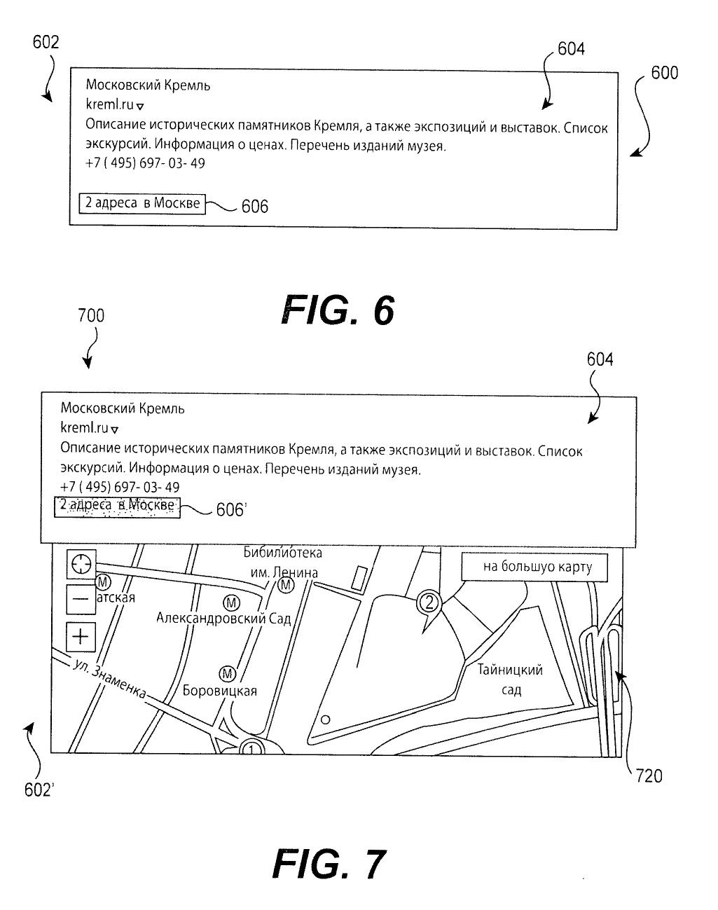

With reference to FIG. 6 and FIG. 7, another example of the first information snippet and the second information snippet are provided. With reference to FIG. 6, there is depicted a screen shot 600. Within the illustrated embodiment, the web browser is Explorer™ accessing the Yandex™ search engine. However, in alternative embodiments, any commercially available or proprietary browser executing any commercially available or proprietary browser can he used.

The screen shot 600 depicts a portion of a SERP (not separately numbered) that is responsive to a search query comprising, in Russian, “Moscow Kremlin”. The screen shot 600 shows a search line 602, the search line 602 including a first information snippet 604. It is noted that the search line 602 can he one of a plurality of search lines (not depicted) within the SERP (not separately numbered).

The first information snippet 604 provides information about the resource, much akin to what was described above in respect to the first information snippet 410 (i.e. title, URL of the resource, brief summary, etc). In accordance with non-limiting embodiments of the present technology, there is also provided an actuation button 606. Within these embodiments, the actuation button 606 is implemented as a square with the text “2 addresses in Moscow” spelled within it in Russian.

Upon the user actuation of the actuation button 606. the display of the search line 602 changes to a search line 602′, a non-limiting embodiment of which is depicted as part of a screen shot 700 shown in FIG. 7. The search line 602′ also shows the first information snippet 604. However, since the user has actuated the actuation button 606, an actuation button 606′ is greyed out to denote the fact that it has been activated. Within the search line 606′, there is also provided a second information snippet 720 (only a portion of which is visible in FIG. 7).

Generally speaking, the second information snippet 720 provides additional information about the resource associated with the search line 604′ (and the search line 604, for that matter). Within the illustration being presented herein, the second information snippet 720 includes a map that is responsive to the search results provided by the user within the query interface 102. It is noted that within this illustration, the second information snippet 720 is fully functional in the sense that the user can interact with the second information snippet 720 to zoom in or out the map view, to move the vantage point on the map, or alternatively open a larger version of the map.

It is noted that the second information snippet 720 is displayed right within the SERP (not separately numbered). Put another way, the second information snippet 720 is displayed without leaving the SERP (not separately numbered). It can also be the that the second information snippet 720 is displayed without generating a pop up window, a separate web browser screen or a separate web browser tab. Specifically, the second information snippet 720 is displayed in close proximity to the first information snippet 604.

Within the illustrated embodiment, the second information snippet 720 is displayed immediately below the first information snippet 604. In alternative embodiments, the spatial relationship between the second information snippet 720 and the first information snippet 604 can be different. For example. the second information snippet 720 can be displayed to the right of the first information snippet 604.

Alternatively, the second information snippet 720 can be displayed to the left of the first information snippet 604. It is also possible that the second information snippet 720 can be displayed on top of the right of the first information snippet 604. Finally, it is contemplated that the second information snippet 720 can partially overlay first information snippet 604. Within some embodiments, it is contemplated that the second information snippet 720 can at last partially replace the first information snippet 604.

It is noted that in the illustrated embodiment, the second information snippet 720 enables the user to appreciate the nature of the resource associated with the third search line 602′. In the specific illustration the second information snippet 720 allows the user to potentially get the answer to her query without leaving SERP (not separately numbered) and without accessing the resource associated with the search line 602. In alternative embodiments, however, rather than providing the map itself within the second information snippet 720, the server 316 may have provided alternative types of additional information. Continuing with the example of the resource being a map service, the second information snippet 720 may contain additional information describing the point of interest, provide other users' comments about the point of interest and the like.

Given the architecture described with reference to FIG. 3 and examples provided with reference to FIGS. 4-7, it is possible to implement a method of presenting search results to a user. It is assumed that the search results have been generated in response to a search query received from the user (i.e. the search query entered by the user using the query interface 102).

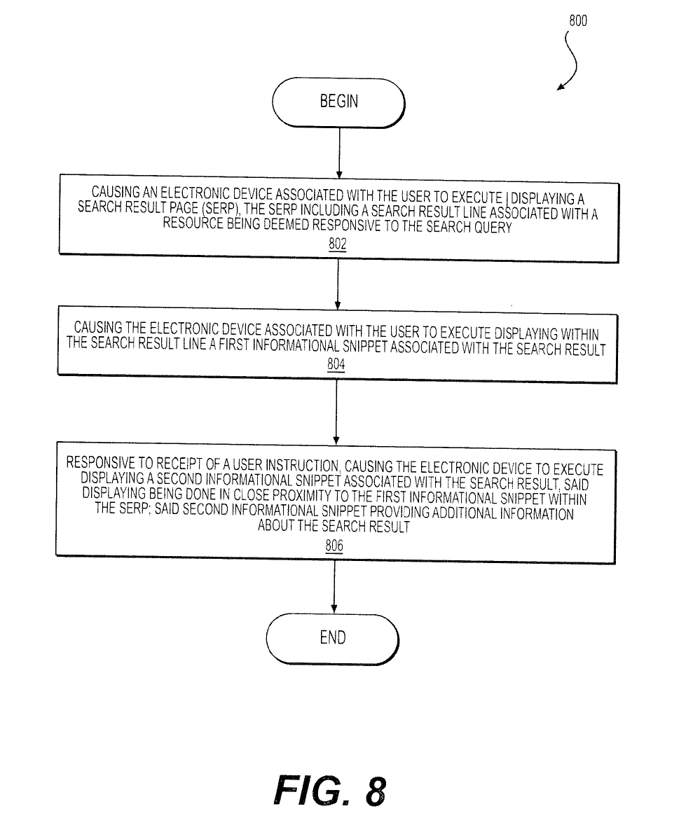

The method can be conveniently executable at the server 316. To that extent, the server 316 comprises non-transient computer usable information storage medium that enables the server 316 to execute the method in accordance with embodiments of the present technology. With reference to FIG. 8, there is depicted a non-limiting embodiment of a method 800, the method 800 for presenting a SERP to a user in response to a search query.

Step 802—causing an electronic device associated with the user to execute displaying a search result page (SERP), the SERP including a search result line associated with a resource being deemed responsive to the search query

The method 800 starts at step 802, where the server 316 causes the electronic device 302 associated with the user to display a search result page (SERP), the SERP including a search result line associated with a resource being deemed responsive to the search query. How the server 316 executes this step is not particularly limited.

In some embodiments of the present technology, the server 316 first executes the search for the user query submitted using the query interface 102 and obtains the ranked search results (for example, using some of the search approaches described herein above). The server 316 can then cause the electronic device 302 to display the SERP to the user. In some specific embodiment, the server 316 sends the electronic device 302 a JSON message containing the information necessary to trigger and enable the electronic device 302 to display the SERP.

The SERP includes a number of search lines, each search line being associated with a resource being responsive to the search query.

The method 800 then proceeds to execution of step 804.

Step 804—causing the electronic device associated with the user to execute displaying within the search result line a first informational snippet associated with the search result

Next, at step 804, the server 316 causes the electronic device 302 to display within the search result line a first informational snippet associated with the search result.

As has been previously described, the server 316 may determine that the search result with the search result line has a hierarchical structure, in a sense that the information snippet associated with the resource can he broken down into a first information snippet portion and a second information snippet portion. Within embodiments of the present technology, the first information snippet can provide a first level of detail about the resource to the user.

Practically speaking, the server 316 causes the electronic device 302 to display the above mentioned first information snippet 410 or the first information snippet 604, in their respective embodiments.

The method 800 then proceeds to execution of step 806

Step 806—responsive to receipt of a user instruction, causing the electronic device to execute displaying a second informational snippet associated with the search result, the displaying being done in close proximity to the first informational snippet within the SERP; the second informational snippet providing additional information about the search result

Next, at step 806, the server 316 causes the electronic device 302, responsive to receipt of a user instruction, to execute displaying a second informational snippet associated with the search result, the displaying being done in close proximity to the first informational snippet within the SERP; the second informational snippet providing additional information about the search result

According to embodiments of the present technology, the server 316 receives an indication of the user instruction representative of the user's desire to view additional information about the resource. This receiving can be executed in response to the user actuating the above-mentioned actuation button 426 or the actuation button 606, depending on the example of the implementation.

In some embodiments, in response to the receipt of the indication of the user instruction representative of the user's desire to view additional information about the resource, the server 316 transmits to the electronic device 302 a trigger to cause the electronic device 302 to display to the user the second information snippet. This trigger can also be transmitted as a JSON message.

In alternative embodiments, the indication of the second information snippet may have been transmitted to the electronic device 302 as part of transmitting the SERP information, for example while executing step 802 or as part of transmitting the first information. In those embodiments, the server 316 also transmits to the electronic device 302 a trigger to cause the electronic device 302 to: (i) first display the first information snippet as part of executing step 804 while not displaying the second information snippet: and then (ii) upon user providing an indication of the instruction, displaying the second information snippet.

The method 800 can then terminate execution. Alternatively, in some embodiments of the present technology, the second information snippet may also be associated with an actuation button. Upon activation of the actuation button, the server 316 can cause the SERP to display a third information snippet, the third information snippet providing additional information about the resource, the additional information can contain an even further description of the resource, above and beyond what has been provided by the first information snippet and the second information snippet.

Generally speaking, it can he said that the second information snippet provides a subset of information from a resource associated with the search result line. In some embodiments, the subset can be sufficient for the user to obtain the information she was looking for without having to access the web sit associated with the resource. As has been shown above, the subset of information allows for interactive options.

In some embodiments of the present technology, the information required to populate the first information snippet and/or the second information snippet is obtained by the server 316. In some embodiments the information can be obtained from the general or the vertical services. For example, in the above example of the second information snippet 720 providing a map, the information can be obtained from the vertical 1 module 324.

Alternatively the information can be obtained through an application programming interface (API) defined directly from the resource associated with the search result.

According to some embodiments of the present technology, there is further provided a method of presenting a search result to a user, the search result having been generated in response to a search query received from the user. The method can be executable at the electronic device 302 associated with the user. The method comprises: displaying a search result page (SERP), the SERP including a search result line associated with a resource being deemed responsive to the search query; displaying within the search result line a first informational snippet associated with the search result: responsive to receipt of a user instruction, displaying a second informational snippet associated with the search result, the displaying being done in close proximity to the first informational snippet within the SERP; the second informational snippet providing additional information about the search result.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of presenting a search result to a user, the search result having been generated in response to a search query received from the user; the method executable at a server; the method comprises:
causing an electronic device associated with the user to execute displaying a search result page (SERP), the SERP including a search result line associated with a resource being deemed responsive to the search query;
causing the electronic device to execute displaying within the search result line a first informational snippet associated with the search result;
responsive to receipt of a user instruction, causing the electronic device to execute displaying a second informational snippet associated with the search result, the displaying being done in close proximity to the first informational snippet within the SERP, the displayed second informational snippet providing a first additional information about the search result, the second information snippet being interactive allowing for user interaction with the second information snippet to obtain a second additional information within the second information snippet and without leaving the SERP.

2. The method of claim 1, further comprising receiving an indication of the user instruction.

3. The method of claim 2, wherein the receiving is executed in response to the user actuating an actuation button on the SERP.

4. The method of claim 3, wherein as part of executing the displaying of the SERP including the first informational snippet associated with the search result within the search result line, the method further comprises causing displaying of the actuation button in association with the first informational snippet.

5. The method of claim 1, wherein causing the electronic device to execute displaying the second informational snippet comprises causing the electronic device to execute displaying the second information snippet without leaving the SERP.

6. The method of claim 1, wherein causing the electronic device to execute displaying the second informational snippet comprises causing the electronic device to execute displaying the second information snippet without displaying a pop-up window.

7. The method of claim 1, wherein causing the electronic device to execute displaying the second informational snippet comprises causing the electronic device to execute displaying the second information snippet below or to the right of the first information snippet.

8. (canceled)

9. The method of claim 1, wherein causing the electronic device to execute displaying the second informational snippet comprises causing the electronic device to execute displaying the second information snippet in place of the first information snippet.

10. The method of claim 1, wherein causing the electronic device to execute displaying the second informational snippet comprises causing the electronic device to execute displaying the second information snippet while at least partially overlaying the second information snippet over the first information snippet.

11. The method of claim 1, wherein the second information snippet provides a subset of information from a resource associated with the search result line.

12. The method of clam 11, wherein the subset of information allows interactive options to the user.

13. The method of claim 11, wherein the subset of information allows the user to obtain an answer to the search query without leaving the SERP.

14. The method of claim 1, wherein said causing the electronic device to execute displaying within the search result line a first informational snippet comprises transmitting a first trigger to the electronic device, the first trigger being instrumental in causing the electronic device to display the first information snippet.

15. The method of claim 1, wherein said causing the electronic device to execute displaying within the search result line a second informational snippet comprises transmitting a second trigger to the electronic device, the second trigger being instrumental in causing the electronic device to display the second information snippet.

16. The method of claim 1, wherein
said causing the electronic device to execute displaying within the search result line a first informational snippet comprises transmitting a first trigger to the electronic device, the first trigger being instrumental in causing the electronic device to display the first information snippet; and
wherein said causing the electronic device to execute displaying within the search result line a second informational snippet comprises transmitting a second trigger to the electronic device, the second trigger being instrumental in causing the electronic device to display the second information snippet.

17. The method of claim 16, wherein said transmitting a second trigger to the electronic device is executed upon receipt of a user instruction.

18. The method of claim 16, wherein said transmitting a second trigger to the electronic device is executed concurrently with comprises transmitting a first trigger to the electronic device, and wherein the method further comprises transmitting a third trigger, the third trigger being instrumental in causing the electronic device to only display the first interactive snippet until receipt of the user instruction.

19. The method of claim 1, further comprising, responsive to receipt of a second user instruction, causing the electronic device to execute displaying a third informational snippet associated with the search result.

20. The method of claim 19, further comprising providing a second actuation button in association with the second information snippet.

21. A server for presenting a search result to a user, the search result having been generated in response to a search query received from the user; the server having a non-transient computer usable information storage medium that stores computer executable instructions, which instructions when executed are configured to render the server operable to execute:
causing an electronic device associated with the user to execute displaying a search result page (SERP), the SERP including a search result line associated with a resource being deemed responsive to the search query;
causing the electronic device to execute displaying within the search result line a first informational snippet associated with the search result;
responsive to receipt of a user instruction, causing the electronic device to execute displaying a second informational snippet associated with the search result, the displaying being done in close proximity to the first informational snippet within the SERP; the displayed second informational snippet providing a first additional information about the search result, the second information snippet being interactive allowing for user interaction with the second information snippet to obtain a second additional information within the second information snippet and without leaving the SERP.

22-40. (canceled)
